(19) United States
(12) Patent Application Publication
(10) Pub. No.: US 2005/0058890 A1
(43) Pub. Date: Mar. 17, 2005

(54) Removable battery pack for a portable electric power tool

(76) Inventors: Kenneth Brazell, Piedmont, SC (US); Thomas Wong Kam Kee, Kowloon (HK)

Correspondence Address: BROOKS KUSHMAN P.C., 1000 TOWN CENTER, TWENTY-SECOND FLOOR, SOUTHFIELD, MI, 48075, US

(21) Appl. No.: 10/662,937

(22) Filed: Sep. 15, 2003

(51) Int. Cl. H01M 2/10

(52) U.S. Cl. 429/99; 429/123; 429/97

(57) ABSTRACT

The present invention discloses a battery pack having an elastic bumper mounted externally to a plastic housing of the battery pack. The plastic housing includes a floor, a circumferential wall expanding upward from an outer peripheral edge of the floor and a cap. The floor, wall, and cap collectively define an enclosed internal cavity wherein a plurality of battery cells are mounted for providing power to the power tool. The elastic bumper serves as a cushion in the event of an impact load exerted on the battery pack or exerted on the battery pack and the associated power tool, if the battery pack or the assembled power tool and battery pack are dropped in an orientation in which the battery pack strikes a hard surface.

### BACKGROUND OF THE INVENTION

1. Field of the Invention

The invention relates to removable battery packs for portable electric power tools.

2. Background Art

In the advent of battery operated cordless power tools, tradesmen, artisans, and even typical homeowners have appreciated the advantages provided by a power tool that does not require a power cord for operation. Accordingly, improvements to cordless power tools have developed in the prior art, many of which relate specifically to removable battery packs. One such improvement includes a foam or rubber element included within a battery pack housing to isolate the battery cells from the housing. The foam or rubber element dampens any vibration or impact loads, experienced by the battery cells, that are applied to the battery housing. The prior art also illustrates various attachment configurations for minimizing the effort required to secure the battery to the power tool. Yet another feature recently introduced in the prior art are ventilation ports provided in the battery for cooling the battery cells housed therein during charging.

A goal of the present invention is to provide a further dampening element for protecting the battery pack and portable electric power tool if the tool is dropped or an impact is applied to the battery pack.

Another goal is to enable the battery pack to be installed on the power tool with the operator using one hand.

### SUMMARY OF THE INVENTION

An aspect of the invention is to provide a portable electric power tool having a plastic housing enclosing a plurality of battery cells mounted therein. The plastic housing includes a floor and a circumferential wall extending from an outer peripheral edge of the floor. A cap cooperates with the housing providing an enclosed internal cavity wherein the battery cells are mounted. A relatively soft elastic bumper is mounted externally to the plastic housing to cushion an impact load exerted on the battery pack, if the battery pack or the battery pack and associated power tool were to be dropped or experience an impact load to the battery pack.

Another aspect of the invention is that the battery pack is provided with a tapered guide-way which cooperates with the corresponding structure and the power tool to enable the battery pack to be slid onto and off of the power tool. A spring biased latch is further provided which latches the battery pack securely in place when properly installed. The latch force is less then the static frictional force exerted by the battery pack when placed upon a smooth dry planar horizontal glass reference surface thereby enabling the user to install the battery pack while supported on the horizontal surface by sliding the power tool onto the battery pack using one hand.

The above aspects and other aspects, objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a side elevational view of a preferred embodiment battery pack assembled to a portable electric power tool in accordance with the present invention;

FIG. 2 is a side elevational view of the battery pack of FIG. 1, illustrated assembled to another portable electric power tool, also in accordance with the present invention;

FIG. 3 is an enlarged fragmentary view of a power tool incorporating the battery pack of the present invention;

FIG. 4 is an enlarged bottom plan view of the battery pack of FIG. 3;

FIG. 5 is a partial section view of the battery pack of FIG. 3 taken along section line 5-5 in FIG. 3;

FIG. 6 is a top plan view of the battery pack of FIG. 3, illustrated without the portable electric power tool;

FIG. 7 is a section view of the battery pack taken along section line 7-7 in FIG. 6;

FIG. 8 is a schematic representation of the battery pack and portable electric power tool of FIG. 1;

FIG. 9 is an enlarged partial section view of the battery pack of FIG. 3;

FIG. 10 is a partial section view of an alternative embodiment battery pack, in accordance with the present invention;

FIG. 11 is a partial section view of an alternative embodiment battery pack, in accordance with the present invention;

FIG. 12 is a partial section view of another alternative embodiment battery pack, in accordance with the present invention;

FIG. 13 is a partial section view of still another battery pack in accordance with the present invention;

FIG. 14 is a partial section view of an even further alternative embodiment battery pack in accordance with the present invention;

FIG. 15 is a side elevational view of an alternative embodiment battery pack in accordance with the present invention; and

FIG. 16 is a side elevational view of another alternative embodiment battery pack in accordance with the present invention.

### DETAILED DESCRIPTION OF THE PREFERRED EMBODIMENTS

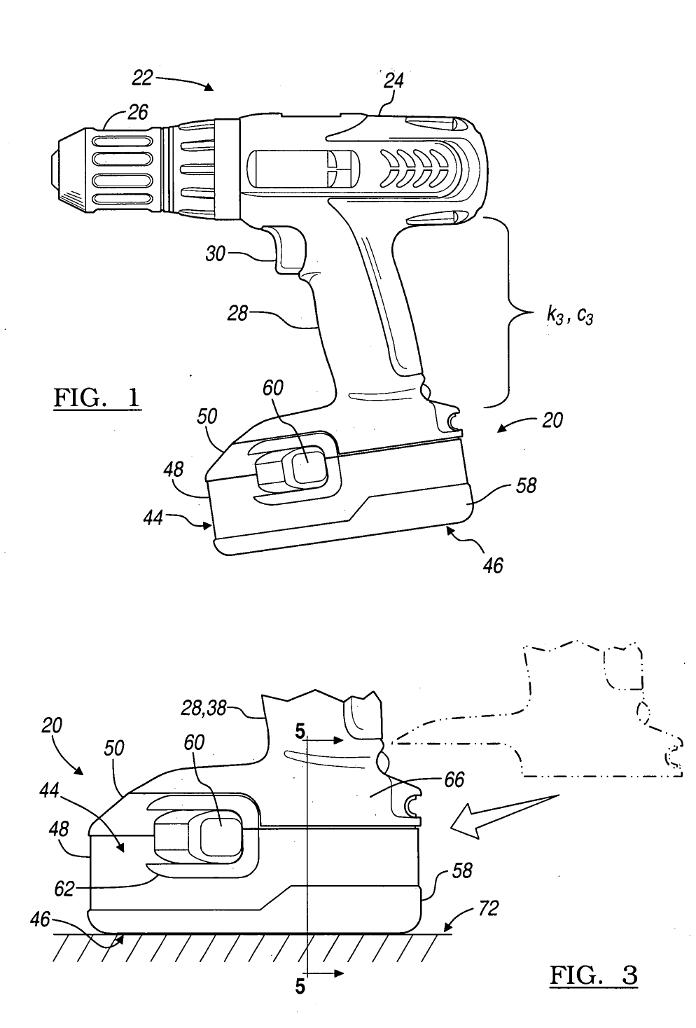

With reference to FIG. 1, a preferred embodiment battery pack 20 is illustrated in accordance with the present invention, and utilized with a portable electric power tool, specifically referred to as a cordless drill 22. The cordless drill 22 has a longitudinal upper housing 24 with a motor and transmission (not shown) disposed therein for driving an output spindle (not shown) and a chuck 26 affixed thereto. The drill 22 includes a pistol grip handle 28, which is formed as part of the housing and extends from the longitudinal housing 24. A trigger switch 30 is displaced from the handle 28 for actuation by a user. The trigger switch 30 is utilized for providing electrical power from the battery pack 20 to the motor disposed within the longitudinal housing 24 for performing a rotary operation or the like to the chuck 26. The drill 22 is similar to the cordless drill disclosed in assignee's U.S. patent application, Three Speed Rotary Power Tool, Ser. No. 10/449,226, which was filed on May 30, 2003, and is incorporated in its entirety by reference herein.

In conventional use of cordless power tools such as the drill 22 of FIG. 1, it is common that the battery pack 20 may be removed at various times at a job site. The battery pack 20 may be removed to be recharged and subsequently an extra battery pack 20 will be affixed to the drill 22. It is also common that cordless power tools may be provided, each adapted to receive a common battery pack. Thus, as the user changes from one power tool to another, the battery pack 20 may be removed from one and secured to the other.

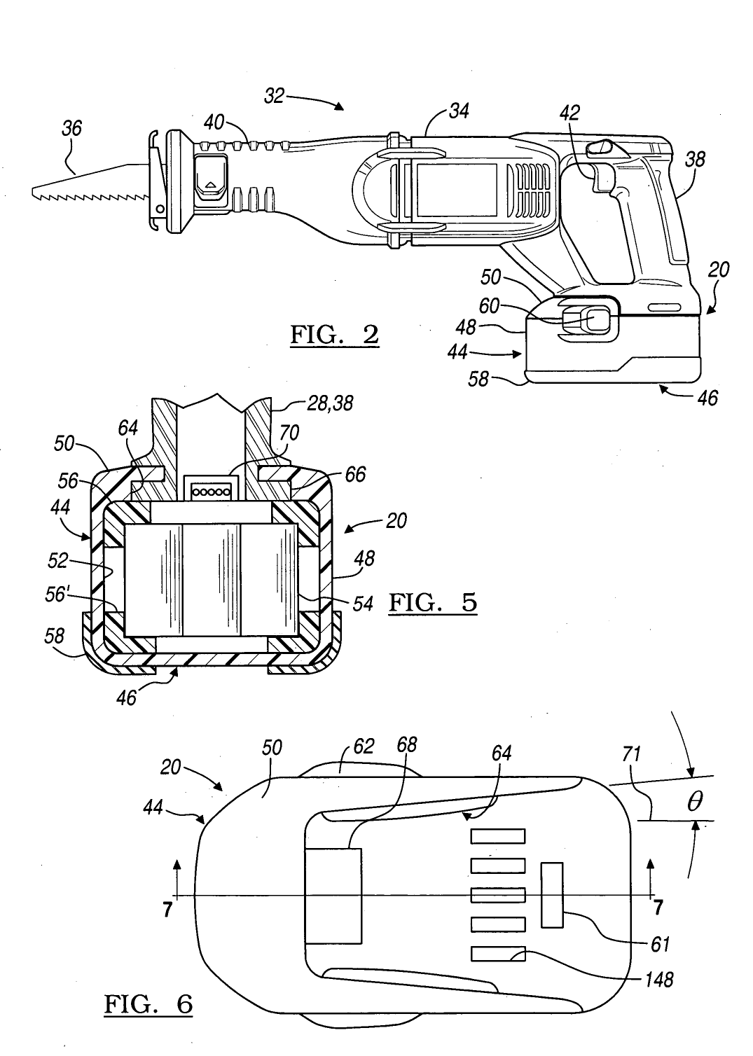

Accordingly, with reference to FIG. 2, another portable electric power tool is illustrated with the battery pack 20 secured thereto. The portable electric power tool of FIG. 2 is characterized as a cordless reciprocating saw 32. The cordless reciprocating saw 32 includes a longitudinal housing 34 with a motor and transmission (not shown) disposed therein for reciprocatingly driving a saw bar (not shown) also oriented therein for driving a tool bit such as a cutting blade 36 that is removably affixed to the saw bar. Reciprocating saw 32 includes a rearward handle 38 and a forward nose portion 40, each of which are sized to be gripped by a hand of the user. The rearward handle 38 also includes a trigger switch 42 for selectively providing current from the battery pack 20 to the motor. The reciprocating saw 32 is similar to the reciprocating saw disclosed in assignee's U.S. patent application, Toolless Blade Holder for a Reciprocating Tool, Ser. No. 10/303,425, and filed on Nov. 25, 2002, which is incorporated in its entirety by reference herein.

Although the exemplary cordless drill 22 and cordless reciprocating saw 32 are illustrated and described, the present invention contemplates utilization of the battery pack 20 with any cordless power tool, including, but not limited to, a cordless circular saw, a cordless sander, a cordless caulking gun, a cordless impact drill, a cordless jigsaw, a cordless miter saw, a cordless planer, a cordless joiner, a cordless router, a cordless scroll saw, and the like.

As the battery pack 20 is interchanged from various power tools or from a tool to a charger; or as the battery pack 20 and the associated power tool are transported to and used in various applications, the battery pack 20 or the battery pack 20 and the associated power tool may be inadvertently dropped on to a relatively hard surface. Dropping of the battery pack 20 or the battery pack 20 and the associated power tool may cause damage to the battery pack 20 and/or the associated power tool. In order to survive certain impact loads, the prior art has provided cordless power tools with a housing design and housing material that is both strong and partially resilient to avoid failures from such impacts. The prior art has also provided battery packs with a housing formed of such material and having a structural design to overcome certain impact loading. Accordingly, the battery pack 20 of the present invention includes a housing 44, formed of a high strength plastic to resist certain impact loads.

Referring now to FIGS. 3-5, the battery pack 20 is illustrated enlarged for further detail. Specifically, the plastic housing 44 of the battery pack 20 has a generally planar floor 46 that is sized to support the battery pack 20 in an upright position when resting on an underlying support surface. The floor 46 may also be sized to stand upright when affixed to certain power tools, such as the cordless drill 22. The plastic housing 44 includes a circumferential wall 48 extending upward from an outer peripheral edge of the floor 46. The battery pack 20 further includes a cap 50, which cooperates with an upper and outer peripheral region of the circumferential wall 48. The cap 50, circumferential wall 48 and floor 46 of the plastic housing 44 collectively define an enclosed internal cavity 52, which is illustrated in the sectional view of FIG. 5.

Referring specifically to FIG. 5, the battery pack 20 includes a plurality of battery cells 54 mounted within the enclosed internal cavity 52. The prior art has protected battery cells from direct impact loading that may be applied to the battery pack housing by including internal, annular, elastic members within the battery pack housing. Accordingly, the battery pack 20 of the present invention includes a pair of internal, annular, elastic members 56, 56′ that are secured within the internal cavity 52 and cooperate with the battery cells 54 thereby suspending the battery cells 54 within the internal cavity 52. Thus, if an impact load is applied to the battery pack housing 44, the internal annular elastic members 56, 56′ dampen the associated impact applied to the plastic housing 44. Further, the internal annular elastic members 56, 56′ help prevent the battery cells 54 from contacting and/or impacting the floor 46, circumferential wall 48 or the cap 50 of the housing 44.

The annular elastic members 56, 56′ have a durometer between 20 Shore O and 80 Shore A, which may be determined more specifically for the associated application. Ideally, a durometer is selected that provides both elastic and dampening characteristics. Additionally, the elastic members 56, 56′ are sized to suspend the battery cells 54 and therefore, have a nominal radial thickness of 0.3 mm to a nominal radial thickness that is 4 times the nominal wall thickness of the plastic housing 44.

The battery pack 20 further includes a relatively soft elastic bumper 58 mounted externally to the plastic housing 44. The elastic bumper 58 of the preferred embodiment is oriented along the plastic housing floor 46 to protect the battery pack 20 and if necessary, the associated power tool by cushioning the impact load exerted on the battery pack 20 when dropped in an orientation in which the battery pack 20 strikes a hard surface. Prior art battery packs typically experience fracture or failure at the outer peripheral edge of the floor 46 due to the impact load being applied to the edge, rather then being distributed over a surface or transmitting high shock loads to the tool housing resulting in a fracture at a remote location. Accordingly, the elastic bumper 58 extends about the outer peripheral edge of the floor 46 and overlays portions of the floor 46 and the circumferential wall 48. The bumper 58 covers and protects the area of the battery pack plastic housing 44 that is most likely to experience an impact load and failure and thus minimizes damage to the battery pack 20. Any durometer of bumper 58 is contemplated, for example, the durometer may be between 20 Shore O and 80 Shore A. However, it is desired to provide the bumper 58 with characteristics that absorb and dampen some of the impact load and therefore a durometer of 20 Shore A to 75 Shore A is preferred. The durometer will be dictated by the bumper thickness, the tool weight and the bumper contact area at the shock point.

Referring again specifically to FIG. 3, the battery pack 20 is provided with a pair of spring biased latch buttons 60 for locking the battery pack 20 to the associated power tool in assembled state via latch pawl 61. The prior art battery packs have been provided with a portion of the plastic housing raised about each latch button to prevent inadvertent unlatching of the battery pack and to minimize impact loads applied to the associated latch for protection thereof. Accordingly, the battery pack 20 includes an elastic bumper 62 formed about each latch button 60, having a lateral thickness that projects outward from the circumferential wall 48 to protect the latch button 60 and to cushion any impact loads applied thereto. The latch elastic bumper 62 may be formed as part of the elastic bumper 58 or as a separate bumper as illustrated in FIG. 3. The lateral thickness of the latch elastic bumper 62 is sized so that it extends outward from the circumferential wall 48, past the latch button 60 in the outwardmost position of the latch button 60 wherein the spring (not shown) that biases the latch button 60 is extended. However, the invention contemplates that the thickness of the latch elastic bumper 62 at least extends outwardly to a distance corresponding with the latch in its compressed orientation to thereby prevent impact loads to the latch button 60. It is ideal to protect the latch buttons 60 of the battery pack 20 because damage to one of the latches 60 may impair or prevent assembly with the power tool.

The battery pack 20 of the preferred embodiment cooperates with the associated power tool in sliding engagement that is generally parallel with the floor 46, commonly referred to as a slide-on battery pack. This engagement is illustrated in FIG. 3 with a lowermost portion of the handle 28 illustrated in solid and assembled with the battery pack 20. The lowermost portion of the handle 28 is also illustrated in phantom in an unassembled orientation relative to the battery pack 20. Prior art battery packs that are referred to as stem battery backs are assembled and disassembled to the power tool by sliding engagement in a direction that is generally perpendicular to the respective floor of the battery pack. Stem battery packs facilitate one handed assembly because the user may compress the latches by pressing the power tool in a direction that is generally perpendicular to an underlying support surface thereby overcoming the spring bias of the latches in assembling the tool.

However, the preferred embodiment is a slide-on battery pack 20 to prevent inadvertent disassembly of the battery pack 20 from the power tool, for minimizing impact loads applied thereto. Such inadvertent disassembly may occur during operation of the power tool, whereby the user may press the battery pack 20 against an object that is proximate the work site or the user may inadvertently depress one or more of the latch buttons while gripping the power tool proximate to or about the battery pack 20. Power tools such as the cordless drill 22 and cordless reciprocating saw 32 are commonly utilized in a generally upright orientation. Therefore, with the slide-on battery pack 20 of the preferred embodiment, dropping of the battery pack 20 is minimized by reducing the probability that gravity will disengage the battery pack 20 from the power tool upon the latch buttons 60 being inadvertently depressed.

Prior art battery packs are known which have a slide-on engagement to the associated power tool. However, the prior art battery packs that assemble and disassemble to the associated power tool in a sliding engagement manner that is parallel to the floor, like the preferred embodiment, typically do not facilitate one handed engagement of the battery pack to the power tool. Using a prior art battery pack as the power tool is pressed in a direction of the arrow in FIG. 3, before the bias force of latch pawl 61 is overcome, causes the prior art battery pack to slide along an underlying support surface. Accordingly, the bumper 58 of the preferred embodiment has a high coefficient of friction to maintain the battery pack 20 in an orientation upon an underlying support surface for one handed assembly. The coefficient of friction should be high enough such that the battery pack 20 has a static frictional force that is greater than the latch force, when the battery pack 20 is placed on a relatively smooth surface such as a smooth, dry, planar horizontal glass reference surface. The coefficient of friction may be high enough so that the dynamic frictional force applied to the battery is greater than the associated latch force so that assembly may still occur even if the battery pack 20 is sliding along the underlying support surface. Accordingly, the elastic bumper 56 should be provided of a material having a high static coefficient of friction, specifically a static coefficient of friction greater than 0.5 when cooperating with a smooth, dry planar glass reference surface. Accordingly, the preferred embodiment has a static coefficient of friction preferably greater than 0.8 when cooperating with a smooth, dry planar glass reference surface.

Referring now to FIGS. 6 and 7, another feature of the battery pack 20 is illustrated. The cap 50 of the battery pack 20 includes a tapered guide-way 64 for releasabily receiving a cooperating mounting flange 66 of the handle 28, 38 of the associated power tool 22, 32. The mounting flange 66 is aligned generally parallel to the floor 46 of the battery pack 20 when in the assembled mode. The battery pack 20 includes a first electrical connector 68 disposed within the tapered guide-way 64. The first electrical connector 68 is electrically connected to the battery cells 54 in a conventional manner. The mounting flange 66 on the power tool includes a corresponding second electrical connector 70 disposed therein as illustrated in FIG. 5 for mating engagement with the first electrical connector 68. Upon engagement of the second electrical connector 70 and first electrical connector 68, power is provided from the battery cells 54 to the motor as controlled by the associated trigger switch 30, 42. The tapered guide-way 64 tapers in both a transverse and vertical direction to accommodate a slight misalignment of the power tool 22, 32 and the battery pack 20 during assembly. Thus, the tapered guide-way 64 assists the user in aligning the plug 68 and receptacle 70. Referring to FIG. 6, the angle of the taper relative to a central longitudinal axis 71 that is parallel to the floor is illustrated by angle θ. Taper angle θ of the preferred embodiment battery pack 20 is approximately 5°, however, any angle that facilitates assembly regardless of slight misalignment is contemplated by the present invention, such as a range of 1° to 10°. Referring to FIG. 7, a vertically tapered angle relative to the central longitudinal axis 71 is indicated by angle θ. Taper angle θ, as contemplated by the present invention, can be any angle for overcoming this alignment, such as 1° to 10°. Taper angle θ of the preferred embodiment is approximately 5°.

As stated before the elastic bumper 58 provides both resilient and dampened support to the plastic housing 44. Accordingly, the elastic bumper 58 is formed of a low durometer rubber material. Referring to FIG. 8, a schematic is illustrated representing the vibrational characteristics of the battery pack 20 and the associated power tool 22, 32. Specifically, a hard surface 72 is depicted at the point of contact with the battery pack 20. Since the elastic bumper 58 has both resilient and shock absorbing characteristics, the bumper 58 is represented by spring k₁ and dampener c₁. Upon impact of the battery housing 44 and the hard surface 72, the resilient characteristics of the elastic bumper 58, represented by k₁ and the shock absorbing characteristics of the elastic bumper 58, represented by c₁ reduce the impact load that is provided to the battery housing 44.

Additionally, the internal elastic members 56, 56′ provided in the internal cavity 52 of the battery housing 44 provide additional resilient characteristics represented by spring k₂ and shock absorbing characteristics represented by dampener c₂ to the battery cell 54. Unlike the prior art, the battery cell 54 is protected from impact loads collectively by the characteristics of the internal elastic members 56, 56′ and the characteristics of the elastic bumper 58.

A portion of the power tool housing that is between the operational elements of the power tool and the battery pack 20 assist in cushioning impact loads that are translated from the battery pack 20 to the operational elements. Although the housing is formed of a relatively rigid material such as high strength plastic, the material still inherently includes resilient and dampening characteristics, although relatively small in comparison to those of the elastic bumper 58 and annular internal elastic members 56, 56′. Specifically referring to the cordless drill 22, such characteristics are provided due to the length of the handle 28 separating the longitudinal housing 24 and the battery pack 20. The resilient characteristics of the handle 28 are represented by spring k₃ and the shock absorbing characteristics of the handle 28 are illustrated by dampener C₃ in FIG. 8. Prior art power tools distribute impact loads imparted to the battery pack 20 from the plastic housing 44 to the longitudinal housing 24 with shock absorbing and cushioning being provided by the minimal characteristics of the handle 28. The preferred embodiment provides additional shock absorption initially at the point of contact of elastic bumper 58. Therefore, the elastic bumper 58 provides additional cushion support to the battery cells 54 and the operational elements of the longitudinal housing 24, while concomitantly protecting the plastic housing 44. The housing of the reciprocating saw 32 provides shock absorption and resilient characteristics, although minimal, in comparison to the cordless drill 22 because the battery pack 20 is located generally adjacent to the longitudinal housing 34.

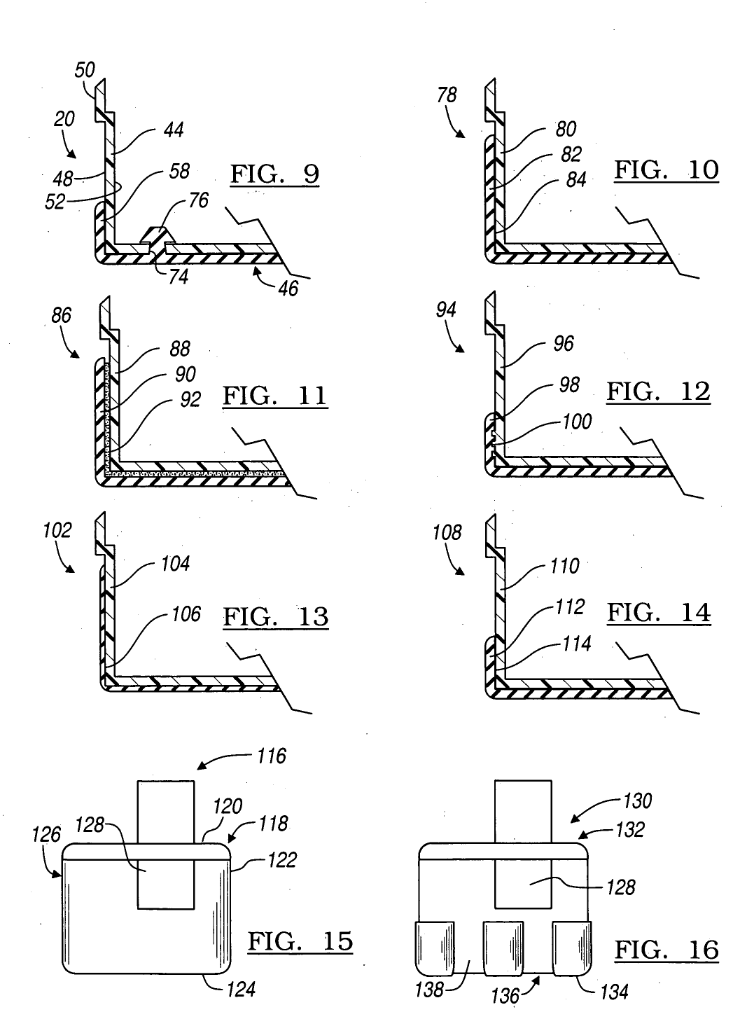

Referring now to FIGS. 9 through 14, a plurality of battery pack bumper details are illustrated in partial section view, including the preferred embodiment battery pack 20 and alternative embodiment battery packs, to demonstrate various manufacturing methods for affixing an elastic bumper to the corresponding plastic housing.

Referring now to FIG. 9, a partial cross section of the battery pack 20 is provided to illustrate the attachment of the elastic bumper 58 to the plastic housing 44. Specifically, plastic housing 44 is formed from an injection molding process providing the plastic housing 44 with a nominal wall thickness ranging from 2.5 mm to 3.5 mm. The elastic bumper 58 is over-molded onto the plastic housing 44 providing a rubbery bumper with a thickness of approximately 1 mm. The plastic housing 44 includes a plurality of apertures 74, one of which is illustrated in FIG. 9, formed therethrough. As the elastic bumper 58 is over-molded onto the plastic housing 44, a projection 76 of the elastic bumper 58 is formed through the aperture 74 thereby mechanically interlocking the elastic bumper 58 to the plastic housing 44. Alternatively, the elastic bumper 58 and projection 76 may be formed separately from the plastic housing 44 and may be fastened thereto, such as by pressing the projection 76 through the aperture 74, thereby mechanically interlocking the elastic bumper 58 to the plastic housing 44. Of course, other common fasteners such as screws, retaining clips or the like are contemplated by the present invention.

Referring now to FIG. 10, an alternative embodiment battery pack 78 is illustrated in accordance with the present invention. The battery pack 78 includes a plastic housing 80 and an elastic bumper 82 that is bonded thereto such that an interface 84 of the bumper 82 and plastic housing 80 is completely melted together. This feature may be provided by over-molding the elastic bumper 82 to the plastic housing 80, or co-molding the elastic bumper 82 and plastic housing 80. The elastic bumper 82 is approximately 1.5 mm to 2 mm in thickness in order to obtain the desired protection characteristics and satisfy the manufacturing requirements.

Referring now to FIG. 11, an alternative embodiment battery pack 86 is provided with a plastic housing 88 and an elastic bumper 90 affixed thereto by an adhesive 92 dispensed therebetween. The adhesive 92 and elastic bumper 90 may be affixed to the plastic housing 88 in a progressive molding operation or by assembly of separate components. The elastic bumper 90 is formed with a thickness of approximately 1 mm, or thicker for protecting the battery pack 86.

Referring now to FIG. 12, another alternative embodiment battery pack 94 is illustrated in accordance with the present invention. The battery pack 94 includes a plastic housing 96 and an elastic bumper 98. The elastic bumper 98 is affixed to the plastic housing 96 through frictional engagement therebetween. Thus, the elastic bumper 98 is formed separately from the plastic housing 96 and is pressed thereon in an assembly operation. Plastic housing 96 further includes a plurality of external ribs 100 formed thereabout for enhancing the frictional engagement within the elastic bumper 98. Additionally, the external ribs 100 may be barbed in a direction corresponding to the direction in which the elastic bumper 98 is pressed thereon to prevent removal of the elastic bumper 98 from the plastic housing 96. Alternatively, the ribs 100 may be provided about the plastic housing 96 and the elastic bumper may be molded thereto for mechanical interlocking engagement with the ribs 100. Elastic bumper 98 is approximately 1 mm or thicker.

Referring now to FIG. 13, yet another alternative embodiment battery pack 102 is provided having a plastic housing 104 and an elastic bumper 106 affixed thereto. The elastic bumper 106 is formed from a liquid elastomeric material that is sprayed onto the plastic housing 104 to cure and form the elastic bumper 106. The material of the elastic bumper 106 is formed from either a regular soft touch paint or a foam type rubbery paint having a thickness of 0.3 mm or greater. The material of the elastic bumper 106 also includes an agent for causing a chemical reaction with the exterior of the elastic housing 104 creating a bond upon curing to secure the elastic bumper 106 to the plastic housing 104.

Referring now to FIG. 14, a still further alternative embodiment battery pack 108 is illustrated in accordance with the present invention. Battery pack 108 includes a plastic housing 110 and an elastic bumper 112 affixed thereto. Elastic bumper 112 is formed from a liquid elastomeric material, preferably molten rubber, and the plastic housing 110 is dipped partially therein. The plastic housing 110 receives a layer of rubber material that either melts with or cures to an interface 114 with the plastic housing 110 thereby creating the elastic bumper 112.

Referring now to FIGS. 15 and 16, alternative embodiment battery packs of the central stem design are illustrated to demonstrate various arrangement of elastic bumpers affixed to the associated plastic housing. These bumper patterns can also be used on a slide-on battery pack as illustrated in FIGS. 1-8.

Referring specifically to FIG. 15, an alternative embodiment stem battery pack 116 is illustrated having a plastic housing 118 with a cap 120 that is adapted for sliding engagement with the associated power tool in a direction that is generally parallel with the handle 28, 38. The battery pack 116 includes an elastic bumper 122 that at least partially covers a floor 124 of the plastic housing 118, covers the peripheral edges of the floor 124 and extends along circumferential walls 126 of the plastic housing 118 partially surrounding an associated latch 128. The elastic bumper 122 protects the floor 124, the peripheral edge thereabout, the latch 128 and a majority of the circumferential wall 26.

With reference now to FIG. 16, another alternative embodiment battery pack 130 is illustrated in accordance with the present invention. The battery pack 130 includes a plastic housing 132 with an elastic bumper 134 affixed thereto. The elastic bumper 134 is defined by a plurality of elastic bumper portions affixed to the plastic housing 132 at a plurality of locations, each covering a region of a floor 136, a circumferential wall 138 and the associated edge portion provided therebetween. The battery pack 130 illustrates that various styles and arrangements of elastic bumpers 134 may be provided, whether formed of a unitary bumper, or a plurality of bumper portions, to protect the plastic housing 132. The elastic bumper portions 134 may save manufacturing material costs by minimizing the amount of rubber applied and may provide various aesthetic battery pack options.

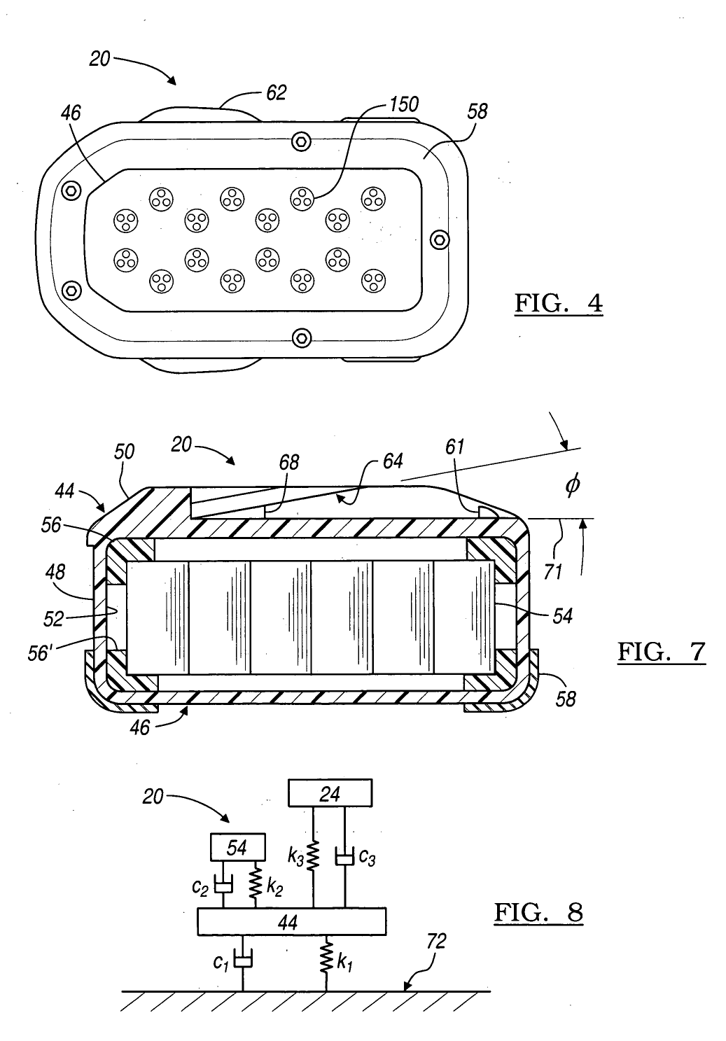

Referring again to FIGS. 4 and 6 of the preferred embodiment battery pack 20, the battery pack 20 includes a plurality of vents 148 provided in the tapered guide-way 64 and aligned with an associated handle 28, 38 for assembly. Additionally, the underside of the battery pack 20 includes another series of vents 150. The vents 148 and 150 are provided for ventilation of the battery 20 as is well known in the art. Thus, as the battery 20 raises in temperature, air is permitted therethrough by convection, or is forced therethrough by a fan of the motor or an additional fan which may be provided within the handle 28, 38 of the specific power tool or within the associated charger. Therefore, it may not always be desired to cover the entire floor 46 of the associated battery pack 20. Ported or vented battery packs are disclosed in assignee's U. S. patent application, “Battery Venting System, Ser. No. ______, which was filed on Jun. 3, 2003 and is incorporated in its entirety by reference herein.

In summary, the present invention provides a simplified and relatively low cost apparatus for preserving battery pack life and power tool life by minimizing damage caused by inadvertent misuse of the tool.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A battery pack for use with a portable electric power tool, comprising:
a plastic housing having a floor, a circumferential wall extending upward from an outer peripheral edge of the floor and a cap cooperating with an upper outer peripheral region of the circumferential wall to define an enclosed internal cavity;
a relatively soft elastic bumper mounted to the plastic housing and extending about the outer peripheral edge of the floor, and overlying adjacent portions of the floor and circumferential wall; and
a plurality of battery cells mounted within the enclosed internal cavity of the plastic housing;
wherein the elastic bumper serves to cushion an impact load exerted on the battery pack and the associated power tool if the battery pack or the electric power tool and battery pack assembly is dropped in an orientation in which the battery pack strikes a hard surface.

2. The battery pack of claim 1 wherein the elastic bumper is over-molded onto the plastic housing.

3. The battery pack of claim 1 wherein the housing floor and the housing circumferential wall are formed from an injection molding process, and the elastic bumper is co-molded therewith.

4. The battery pack of claim 1 wherein the elastic bumper is mechanically interlocked with the plastic housing.

5. The battery pack of claim 1 wherein the plastic housing includes at least one aperture formed therethrough for receiving a projection of the elastic bumper for mechanically interlocking the elastic bumper thereto.

6. The battery pack of claim 1 wherein the elastic bumper is affixed to the plastic housing by an adhesive applied therebetween.

7. The battery pack of claim 1 wherein the elastic bumper is secured to the plastic housing by a frictional fit therebetween.

8. The battery pack of claim 1 wherein the plastic housing includes a plurality of external ribs for frictional engagement with the elastic bumper.

9. The battery pack of claim 1 wherein a liquid elastomeric material is sprayed onto the plastic housing to form the elastic bumper.

10. The battery pack of claim 1 wherein the plastic housing is dipped into a liquid elastomeric material to form the elastic bumper.

11. The battery pack of claim 1 wherein the elastic bumper is separately formed and fastened to the outer peripheral edge of the plastic housing.

12. The battery pack of claim 1 wherein the elastic bumper has a nominal wall thickness of 0.3 millimeters to four times a nominal wall thickness of the plastic housing.

13. The battery pack of claim 1 wherein the elastic bumper has a nominal wall thickness of 0.75 millimeters to 2 millimeters.

14. The battery pack of claim 1 wherein the elastic bumper has a durometer of 20 Shore O to 80 Shore A.

15. The battery pack of claim 1 wherein the elastic bumper has a durometer of 20 Shore A to 75 Shore A.

16. The battery pack of claim 1 wherein the elastic bumper has a static coefficient of friction of 0.5 or greater when cooperating with a smooth, dry planar glass reference surface.

17. The battery pack of claim 1 further comprising an internal annular elastic member suspending the battery cells within the enclosed internal cavity of the plastic housing.

18. The battery pack of claim 17 wherein the annular elastic member has a durometer of 20 Shore O to 80 Shore A and a nominal radial thickness of 0.3 millimeters to four times a nominal wall thickness of the plastic housing.

19. The battery pack of claim 1 wherein the plastic housing is provided with at least one spring biased latch, which locks the battery pack and the power tool in an assembled state; and
wherein at least a portion of the elastic bumper is oriented proximate to the latch.

20. The battery pack of claim 19 wherein the latch projects from the housing a predefined distance when the spring is compressed, and the at least a portion of the elastic bumper has a thickness that is greater than the predefined distance.

21. The battery pack of claim 1 wherein the cap is provided with a tapered guide-way for releasably receiving a cooperating mounting flange on the power tool, when a power tool is moved relative to the battery pack, along a longitudinal axis which is generally parallel to the floor of the battery pack.

22. The battery pack of claim 21 wherein the tapered guide-way tapers in both a transverse and vertical direction to accommodate a slight misalignment of the power tool and battery pack during assembly.

23. The battery pack of claim 22 wherein the cap of the battery pack is provided with a spring biased latch, which locks the battery pack and the power tool in an assembled state, wherein the spring biased latch has a latch force during assembly which is less than the static frictional force exerted by the battery pack when placed upon a smooth dry planar horizontal glass reference surface, thereby enabling a user to install the battery pack while placed on a horizontal surface onto the power tool using one hand.

24. The battery pack of claim 23 wherein the guide-way tapers 1° to 25° transversely relative to a central longitudinal axis parallel to the floor.

25. The battery pack of claim 23 wherein the guide-way tapers 1° to 25° vertically relative to a central longitudinal axis parallel to the floor.

26. A battery pack for use with a portable electric power tool, comprising:
a plastic housing having a floor, a circumferential wall extending upward from an outer peripheral edge of the floor and a cap cooperating with an upper outer peripheral region of the circumferential wall to defme an enclosed internal cavity;
a relatively soft elastic bumper mounted externally to the plastic housing; and
a plurality of battery cells mounted within the enclosed internal cavity of the plastic housing;
at least one spring biased latch, which locks the battery pack and the power tool in an assembled state;
wherein at least a portion of the elastic bumper is oriented proximate to the latch and the elastic bumper serves to cushion an impact load exerted on the battery pack and the associated power tool if the battery pack or the electric power tool and battery pack assembly is dropped in an orientation in which the battery pack strikes a hard surface.

27. The battery pack of claim 26 wherein the elastic bumper is mounted to the plastic housing floor.

28. The battery pack of claim 26 wherein the elastic bumper overlies portions of the floor and circumferential wall.

29. The battery pack of claim 26 wherein the elastic bumper extends about the outer peripheral edge of the floor.
